(19) United States
(12) Patent Application Publication
(10) Pub. No.: US 2014/0101006 A1
(43) Pub. Date: Apr. 10, 2014

(54) Pass-Through Entities Visualization

(71) Applicant: Bruce L. Pitt, Broomes Island, MD (US)

(72) Inventor: Bruce L. Pitt, Broomes Island, MD (US)

(21) Appl. No.: 13/803,125

(22) Filed: Mar. 14, 2013

Related U.S. Application Data
(60) Provisional application No. 61/636,875, filed on Apr. 23, 2012.

(51) Int. Cl. G06Q 50/26; G06Q 40/00

(52) U.S. Cl. CPC G06Q 50/26; G06Q 40/12
USPC 705/30

(57) ABSTRACT

A tax visualization program which uses the SAS Social Network Analytics tool or other link analysis or social network analytics tools, and as a tool for the tax examiner, providing near instantaneous access to the pass-through data related to an individual or entity under tax examination. The pass-through data can provide a view of various patterns of compliance risk, inappropriate/abusive preparer behavior, enterprise ownership and control, as well as provide a diverse network analysis of people, documents, data, and organizational entities. A method which identifies abusive tax transactions by pass-through entities is also included. A system which identifies abusive tax transactions by pass-through entities which interacts with government tax administration agencies and commercial analytical systems is also included.

### CROSS REFERENCE TO RELATED APPLICATIONS

This application claims priority to U.S. Provisional Application No. 61/636,875, filed Apr. 23, 2012.

### GOVERNMENT INTERESTS

Certain research which gave rise to the present invention was supported by the IRS Federally Funded Research and Development Center (FFRDC) Contract # TIRNO-99-D-00005. Consequently, the government may retain certain rights in the invention.

### BACKGROUND

1. Field of the Invention

This invention, Pass-through Entities Visualization (“PTEV”), relates to a software system and product for detection of tax noncompliance and fraud.

2. Background of the Invention

There are significant domestic and offshore tax compliance issues evident in the areas of partnerships, closely held corporations, trusts, pass-through entities and high-wealth individual taxpayers. And in recent years, most state tax agencies are reporting dramatic increases in pass-through filings in both volume and complexity, while experiencing reductions in corporate filings. In addition, the IRS annually addresses transactions of an abusive nature which commonly use pass-through entities to inappropriately reduce tax liabilities of taxpaying entities.

When dealing with pass-through entities including partnerships, S-corporations, trust returns or various other non-taxpaying pass-through entities, the common linkage is the filing of Schedule K-1, which is used to report income (or loss), credits and deductions to members, partners, shareholders and beneficiaries connected with those filings. Schedule K-1 filings from pass-through entities can be easily used to create tiered relationships that allow for manipulation of taxable income through fragmentation, inappropriate offset and hiding of abusive transactions.

Dealing with the potential tax compliance issues is hampered by the sheer volume of transactions, requiring a technological approach to focus on the critical few targets of interest to a government taxing agency.

### SUMMARY OF THE INVENTION

The present invention is drawn to a software product which identifies abusive tax transactions by pass-through entities. A method which identifies abusive tax transactions by pass-through entities is also included. A system which identifies abusive tax transactions by pass-through entities which interacts with government tax administration agencies and commercial analytical systems is also included.

### BRIEF DESCRIPTION OF THE FIGURES

FIG. 1 depicts a typical user request

FIG. 2A depicts a visualization example.

FIG. 2B shows a legend for entities.

FIGS. 3A-3C depict examples of tiering; FIG. 3A depicts a single tier.

FIG. 3B represents a two-tier designation.

FIG. 3C represents three tiers.

FIG. 4 depicts multiple graph results in a single window; FIG. 4A represents a graphical representation of a first TIN entry.

FIG. 4B depicts a second graphical representation of a TIN unrelated to the FIG. 4A TIN, and shown on the same screen.

FIG. 4C depicts a third graphical representation of a TIN unrelated to the FIG. 4A or 4B TINs, and shown on the same screen.

FIG. 4D depicts a fourth graphical representation of a TIN unrelated to the FIG. 4A, 4B or 4C TINs, and shown on the same screen.

FIG. 5A depicts a visualization of interpreting TINs.

FIG. 5B depicts a visualization of interpreting patterns and/or colors.

FIG. 5C depicts a visualization of interpreting shapes.

FIG. 5D depicts a visualization of interpreting lines.

FIG. 5E depicts a visualization of interpreting link information.

FIG. 6 depicts a visualization of interpreting node information.

FIG. 7A depicts a visualization of an expanded node.

FIG. 7B depicts the visualization of the expanded entity shown in FIG. 7A.

FIG. 7C depicts the visualization of the expanded address node shown in FIG. 7A.

FIG. 7D depicts the visualization of the expanded address node shown in FIG. 7C.

FIG. 7E depicts the visualization of the expanded preparer nodes shown in FIG. 7A.

FIG. 8 depicts the visualization of expanding node options.

FIG. 9 depicts the visualization of moving nodes;

FIG. 9A depicts an original graphical output.

FIG. 9B depicts movement of the node representations from FIG. 9A.

FIG. 10A depicts an original graphical representation with many nodes.

FIG. 10B is a display of the magnified “zoom selected”.

FIG. 11 depicts the visualization of finding common addresses.

FIG. 12 depicts the visualization of finding common preparers.

FIG. 13A depicts a menu for changing the layout using pre-selected layouts.

FIG. 13B depicts and original graph.

FIG. 13C depicts a hierarchical arrangement.

FIG. 13D depicts an orthogonal arrangement.

FIG. 13E depicts an organic arrangement.

FIG. 13F depicts a circular arrangement.

### DETAILED DESCRIPTION OF THE INVENTION

The tax visualization program of the invention is capable of using the SASS Social

Network Analytics (“SNA”) tool or other link analysis or social network analytics tools, and is a powerful technological tool for the tax examiner, providing near instantaneous access to pass-through entity data related to an individual or entity under examination. This pass-through entity data can provide a view of various patterns of compliance risk, inappropriate/abusive preparer behavior, enterprise ownership and control, as well as provide a diverse network analysis of people, documents, data, and organizational entities. The unique ability to drill down to information node by node can provide the examiner with layers of data previously unavailable without numerous hours of resource intensive research, much of which turns out to be of little or no interest in a compliance engagement. By utilizing various filters and user-defined thresholds, examiners can zero in on the most critical and useful information, creating efficiencies in application of time and limited resources.

“A picture is worth a thousand words” and visualization of the financial and corporate relationships of an entity can be useful in planning the scope of an audit, for example. Visualization can help to highlight returns of interest and help by-pass tiers that are not of interest. Such visualization can be helpful for risk analysis, as patterns or “footprints” may indicate shelter activity or other tax compliance issues. Visualization may further identify unknown investors and help organize data from other sources.

The present invention is drawn to a taxpayer compliance software application for pass-through entities and high wealth individuals. The application analyzes IRS information return master file (“IRMF”) data on forms K-1 issued by Partnerships, 11205 Corporations and Trusts, and may also utilize other data sources specific to each customer.

The IRMF processing creates a master file of current tax year information returns and maintains access to five prior years. Beginning in May of each year, extracts are made from the entire IRMF weekly. The primary customers for this information are examination, collection, federal/State relations, criminal investigation and research. Data is also provided to federal and state agencies. The taxpayer (payee) information is reported using a variety of forms and include information such as wages, dividends, interest, cash payments, shareholder income, etc., and information to identify both the payee and payer (name, TIN and address). Master files by definition do not have an audit trail. They are defined as having interfaces to systems that maintain their own audit trails. There is no direct access to IRMF data. All access is through batch files. The data viewed by authorized IRS employees is a copy of the IMF data loaded into any of a number of other systems that have a user interface. These systems maintain the authentication and authorization required, including the use of audit trail information. The data is reported by the payer on various forms and schedules (F1096, F1042, F1098, F1099, Schedule K-1, F5498, F5500, F8300 and F8362). The Form 5500, for example, entitled, the “Annual Return/Report of Employee Benefit Plan,” and including all required schedules and attachments, is used to report information concerning employee benefit plans and Direct Filing Entities (“DFEs”). Any administrator or sponsor of an employee benefit plan subject to ERISA must file information about each benefit plan every year (pursuant to IRS Code section 6058 and ERISA sections 104 and 4065). Some plans participate in certain trusts, accounts, and other investment arrangements that file a Form 5500 annual return/report as DFEs. The IRS, Department of Labor (“DOL”), and Pension Benefit Guaranty Corporation have consolidated certain returns and report forms to reduce the filing burden for plan administrators and employers. Employers and administrators who comply with the instructions for the Form 5500 generally will satisfy the annual reporting requirements for the IRS and DOL.

The Social Security Administration provides the data reported on W-2s, W-3s, W-4s and the Customs Service reports International Transportation of Currency or Monetary Instruments (“CMIR”). Each data item required for the business purpose of the system is listed as the name, TIN, and address, which are required to identify the taxpayer's account. The income, deductions, credits, etc. as reported on the tax return, as well as any payments received, are required to settle the taxpayer's account, and maintain a record of taxes assessed, abated and collected. The IRS monitors the compliance of payers required to report income for accuracy, timeliness and completeness. This payer compliance program works to bring payers into compliance, but has the authority to assess penalties for each information return reported with errors. IRMF data is not directly accessible by users. Data is extracted on a weekly basis for reports and for loading into other IRS systems, which provide read-only access to the data (on a need to know basis). The data are extracted by criteria or status. Every case which meets the criteria or status is extracted. The data is retrievable by a personal identifier such as name, SSN, or TIN. (Modified from IRS website, worldwide web address: irs.gov/privacy/article/0,,id=164735,00.html, accessed Mar. 19, 2012).

The invention, PTEV, generates a social network-like visualization linking pass-through entities with the partners, investors and beneficiaries involved in them. The visualization includes, but is not limited to: 1) identifying related entities, 2) identifying known high-risk patterns, 3) identifying related entities presenting risk, 4) allowing the user to understand who actually controls the enterprise being visualized, 5) providing detailed information for each node/link to support deeper analysis, 6) visualizations that can be reorganized to reveal additional risks, clarifications, and 7) providing a diverse network analysis encompassing people, documents, and economic data. PTEV can be used across industries and market segments to augment classification and/or audit business processes. Additionally, the invention permits nodes and links to be queried to provide more detailed information. Also, graphs can be expanded to pursue nodes of interest and reorganized to make them clearer.

Source(s) of raw data include but are not limited to IRS Governmental Liaison Data

Exchange Program (“GLDEP”) extracts, information return master file (“IRMF”), individual master file (“IMF”), individual return transaction files (“IRTF”), business master file (“BMF”), business return transaction files (“BRTF”), modernized electronic files (“MeF”), etc.), various relevant state extracts, such as state tax return filings, enforcement data for examination and collection programs, state motor vehicle data, and other sources as applicable to the specific implementation. The GLDEP is the name given to certain data-sharing activities that take place between IRS and state tax agencies. IRS shares federal tax data with these agencies by providing them with specific data extracts on a recurring basis to assist with tax administration. A data extract is a computer-generated file that contains specific data elements. For purposes of the GLDEP, a state is defined as any of the 50 states, the District of Columbia, certain U.S. possessions or territories, and any municipality with a population in excess of 250,000 that imposes a tax on income or wages (IRC §6103(b)(5)). The GLDEP minimizes the need for state tax personnel to inspect or obtain paper copies of federal tax returns and related records. Each data extract contains specific data elements that come from tax returns or accompanying documents. Information from the extracts is used in a variety of ways to assist with tax administration. (Modified from the IRS website: world wide web: irs.gov/irm/part11/irm_{—}11-004-002.html).

Visualization

The volume of information in its raw form is of minimal use and requires significant expended resources to manually extract usable data. However, when effectively integrated and managed, this data can: provide a “visual” picture of individual/entity/preparer relationships, identify patterns of taxpayer compliance risk, identify patterns of inappropriate preparer conduct, identify enterprise ownership and control, identify relationships between closely held entities, identify previously unknown investors, drill down into underlying data for additional information, linkages, identify related entities representing compliance risk, provide a diverse network analysis of people, documents, data, and organizational entities, and assist significantly in planning the scope of a compliance engagement.

Visualization provides a graphic representation of a given taxpayer and their relationship to other entities. It can also display multiple levels of tiering such as those representing targets of interest, as well as those which are desired to bypass such as in the event that one entity is invested into the hierarchy of another. The visualization is only limited by the data that has been integrated. So long as there is a linkage available (i.e., SSN/EIN), visualization graphs are inclusive of all relevant data that can be integrated.

Through the use of SAS® Social Networks Analytics Tool, all relevant and available sources of data can be integrated and linked in order to provide an instant visualization of all investor relationships. Manual research of available data by taxpayer identification number (“TIN”) is resource intensive and inefficient and cannot duplicate this output.

Visualization Data Sources

Visualization data sources include IRS BMF and BRTF extracts; IRS Forms 1120-S, 1041, 1120, 1065, 990, 5227, and/or 5500 and/or any equivalent state forms; IRMF extracts such as IRS Forms K-1, 1120-S, 1041, and/or 1065 and/or any equivalent state forms; IMF and IRTF extracts such as Form 1040 and/or Schedule E; MeF; and IRS Forms 1120, 1120-F, 1120S, 1120 and any variants and/or equivalents.

Sharing Output

Once an analysis has identified information of interest, output can be exported in a variety of ways for documentation or archival purposes. Some examples include electronic output using Adobe PDF, Microsoft (“MS”) POWERPOINT, MS WORD; and MS PAINTBRUSH. Data underlying an entity of interest can also be saved as RTF Data for additional research or documentation purposes, or printed in written form.

Embedded Characteristics

Contained within the data are certain characteristics that are of interest to an examiner using the invention for analytical purposes, as described below.

Tax Haven Indicators

The tax haven indicator is based on whether the K-1 is received from an entity located in a tax haven country. The node address will often be a US address of the preparer or a parent/Tax Matters Partner (“TMP”) entity. The same principle applies to payee addresses in non-haven foreign countries. A TMP is a statutory representative which acts as the liaison between the partners of a Tax Equity and Fiscal Responsibility Act of 1982 (“TEFRA”) entity, the IRS and the courts in any TEFRA unified proceedings, as defined in IRS manual sections 8.19.1.6.5 et seq.

Tax Shelters

Tax shelters are of particular interest due to the nature of the transactions these entities may be involved in, and have potential compliance issues of interest to a user of the invention. To the extent that tax shelter activity can be identified it is visually flagged by the invention for purposes of providing additional analytics.

Total Positive Income (“TPI”)

For individual taxpayers receiving pass-through distributions on a Schedule K-1, TPI can be a distinguishing feature of interest to the user. The invention establishes a methodology for setting the threshold TPI for purposes of flagging the Form 1040 (i.e., specific color or pattern shading if TPI is greater than $250,000) for purposes of potential further analytics.

BRTF High Assets

When a business entity is large enough, it can be flagged for asset amounts greater than specified threshold (i.e., specific color or pattern shading if assets greater than $10,000,000) for potential further analytics.

“Drill Down” Information

Due to the nature of the underlying data, it is critical to be able to find associated data whenever analyzing an entity of interest. For example, address information can provide additional network relationships of interest to a user and would be available using drill down techniques as feature of PTEV. Similarly, a common return preparer provides additional levels of network relationships of interest to a user, and can be determined if included within the available data. The availability of “drill down” information is only limited by the data included within the invention for reference purposes.

Safeguard Requirements

The state tax or other governmental agency is responsible for safeguarding the confidentiality of tax return information in all media, whether paper or electronic, in accordance with IRC section 6103(p)(4). Since much of the information utilized in PTEV includes Federal returns and return information, it must be used in accordance with the provisions of IRC section 6103(d) for the purpose of state tax administration. PTEV uses integrated downloads of actual taxpayer data, and as such is protected from unauthorized disclosure. Proper safeguards are followed to ensure that any output from the program is protected and NOT shared inappropriately with the taxpayer.

Example of Output

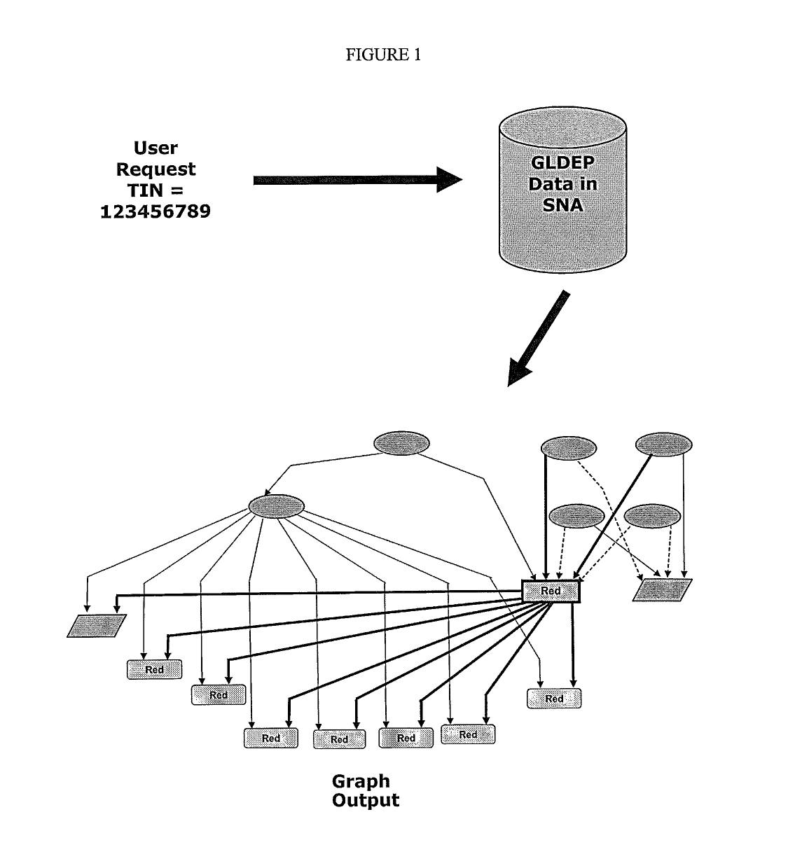

Demonstrating the complex web of interactions often seen in pass-through entity company tax returns, FIG. 1 depicts a visualization of entity relationships generated by the program of the invention, which presents a powerful tax examination tool. Typically, the taxing agency receives only a tax return from an entity and often no other linkages to other entities. Using the invention PTEV, a typical user would enter the Taxpayer Identification Number (“TIN”) of the entity of interest and the SNA Tool would create a visual image of the network of relationships between the entity of interest and all other related entities. This might include the receipt of K-1s from various pass-through entities, or it may include the issuance of K-1s to other entities. The entity of interest can be an issuer of K-1s, a recipient of K-1s or both. The graphic depiction displays all of the related entities found within the available data, and establishes the directional flow of K-1 distributions of income or loss (or other money amounts) with arrow lines of various types. Basic characteristics of money amounts inherent within the data can be visually presented as well.

FIG. 1 depicts how a user (tax administration official) would interact with the invention for purposes of creating the visualization. Through various other means available, the user will have identified an “entity of interest” represented by the unique TIN assigned to the entity. Using the program-supplied interface, the user would interactively input the TIN of the entity of interest via data entry. The invention would utilize the program to extract relevant linked data derived in part from IRS GLDEP extracts and display these relationships graphically on a computer screen. The visualization would utilize predetermined shapes as images representing specific entities and establish the relationships between entities with directional arrow lines. The bold “red” rectangle represents the original input TIN of an s-corporation. The visual depiction would also include underlying data characteristics represented by degree of shading, pattern or color as determined by user requirements.

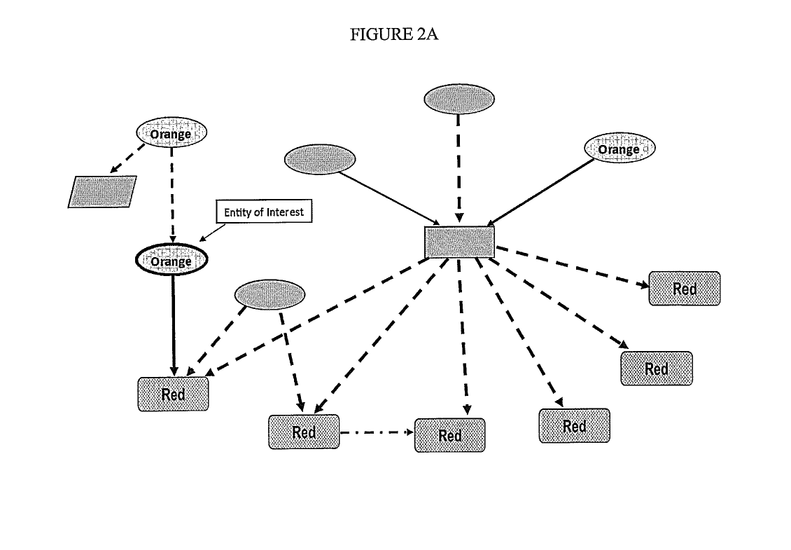

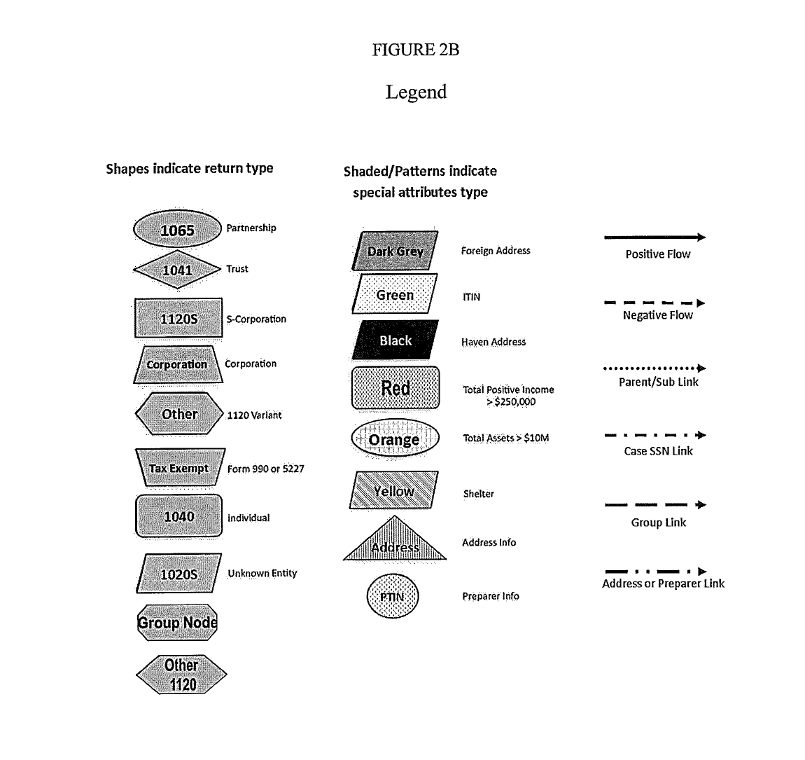

FIG. 2A depicts a PTEV visualization example with linked relationships to partnerships, s-corporations, individuals and at least one unknown entity. Color coding or pattern shading of entities and connecting lines provide underlying characteristics relative to each item, such as pass-through income or loss, high asset value and total positive income of the individual. The user is able to determine in one screen shot, the many interactions between individuals and entities related and interconnected with the entity of interest, shown as the orange bold oval, representing the entity of interest

FIG. 2B provides a legend describing entity shapes, colors, patterns and other characteristics like foreign address, tax haven address, levels of assets and/or income. There are shapes for partnerships, trusts and s-corporations as pass-through entities, and tax paying entities including corporations and individuals. Using color coding or patterns for connecting lines indicate positive or negative flows of income, and various linkages to establish relationships between entities. Address and Preparer symbols are also provided as additional available information. Not to be limiting, shapes denote various return types, shaded or patterns indicate special attribute types, such as foreign addresses, total income >$250,000 USD, tax shelter, preparer information and the like. Lines indicate positive or negative monetary flow, Parent/sub link, and the like.

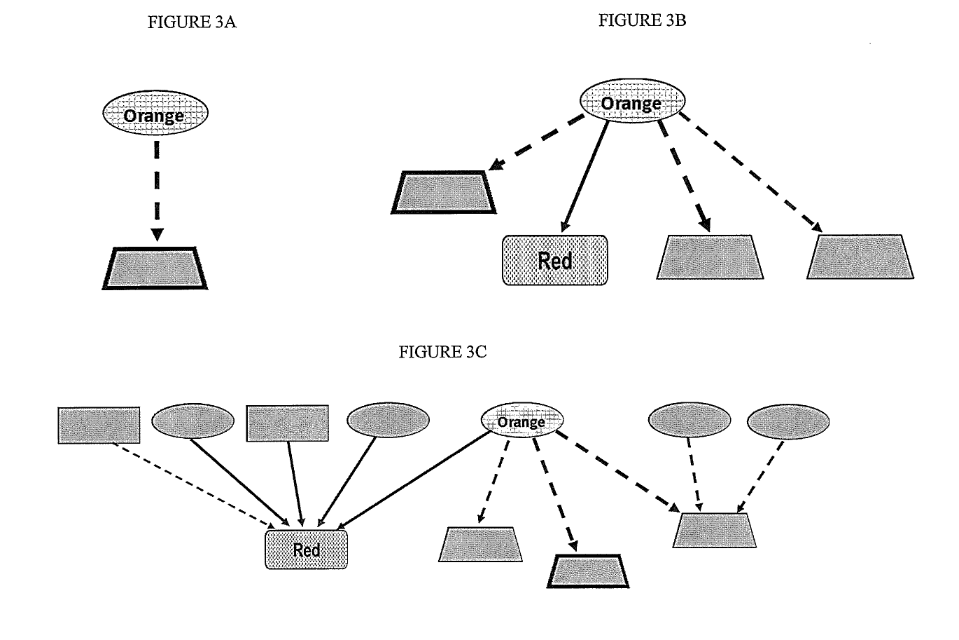

FIGS. 3A, 3B and 3C provide different examples of tiering that may exist within the data, and which would be of interest to a user. As non-taxpaying entities, partnerships, trusts and s-corporations issue K-1s to member/partners, beneficiaries and shareholders respectively, which can in turn be non-taxpaying entities as well. Each “layer” of entities represents a tier for purposes of illustration within the visualization process. Although there is no theoretical limit to the number of tiers that could exist, the more tiers that exist, the more complex the relationships. FIG. 3A represents 1 tier, FIG. 3B represents a 2 tier designation and FIG. 3C represents 3 tiers, with the bold trapezoid representing the original TIN input.

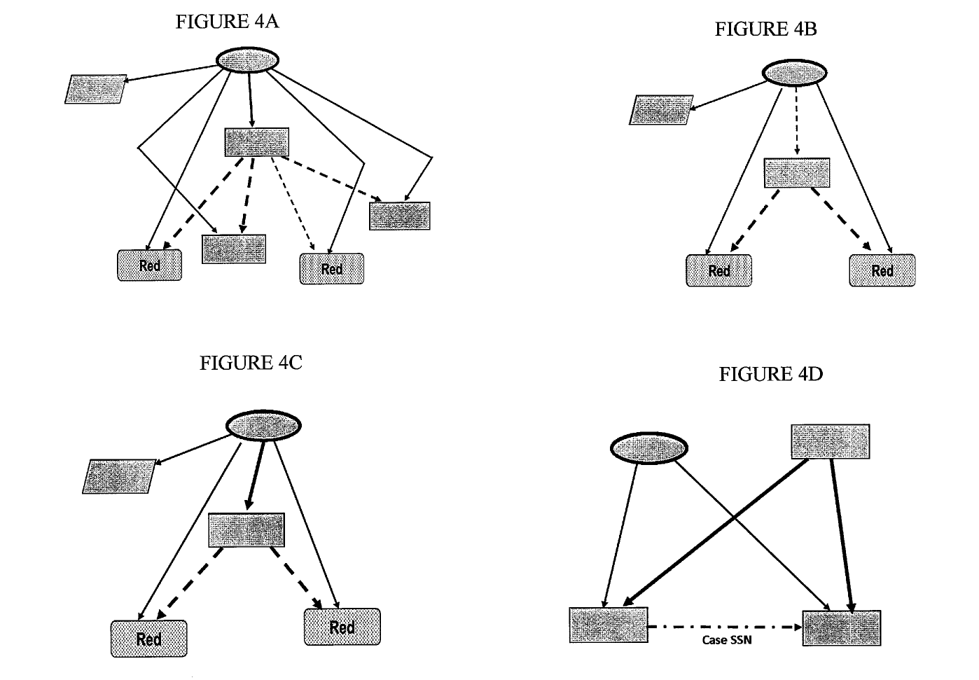

FIGS. 4A-4D depict multiple graph results that may exist in a single window. In this example, 4 different TINs were input (represented by bold border) and four unrelated graphs are drawn. FIGS. 4A-4D represent the lack of linked relationships for these 4 different TIN entities. Interpretations include additional data available for pass-through amounts of income or loss represented by both numbers and line color/thickness, entity characteristics like asset size or total positive income for individuals, and unique shapes for different entities.

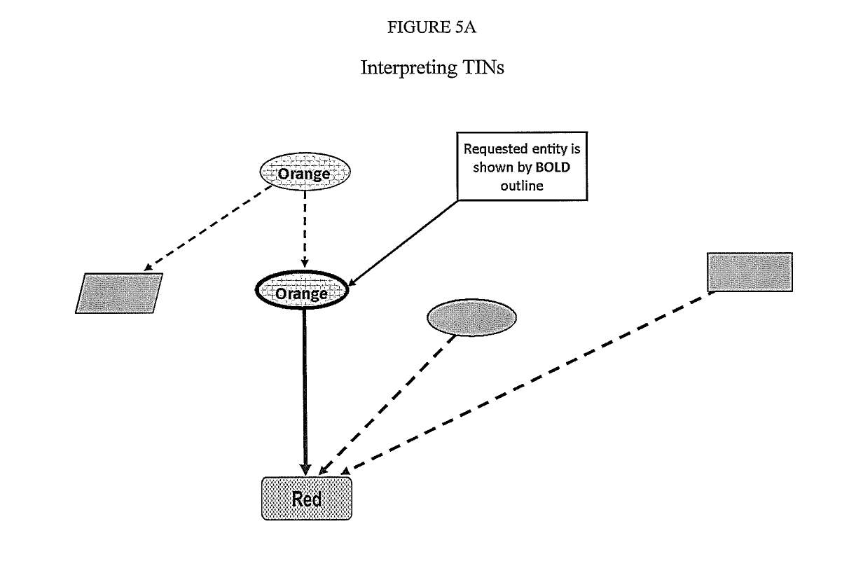

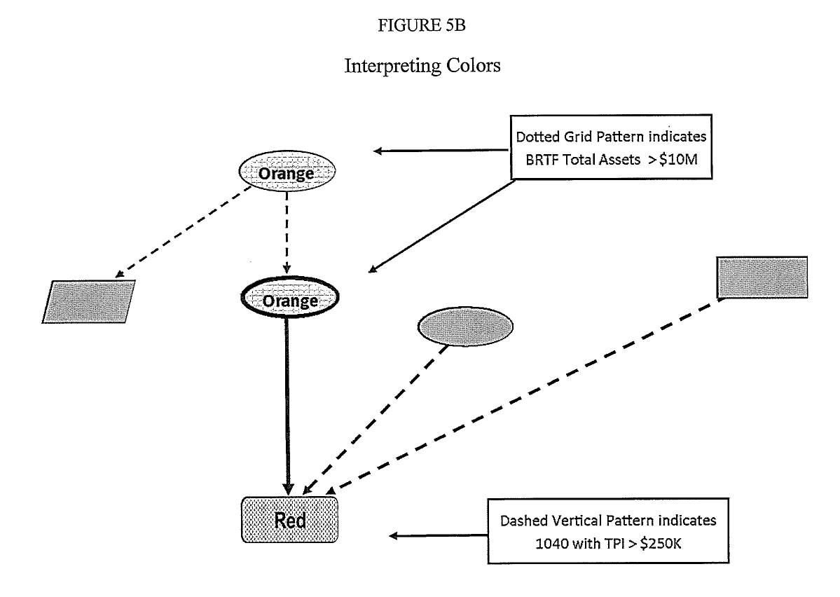

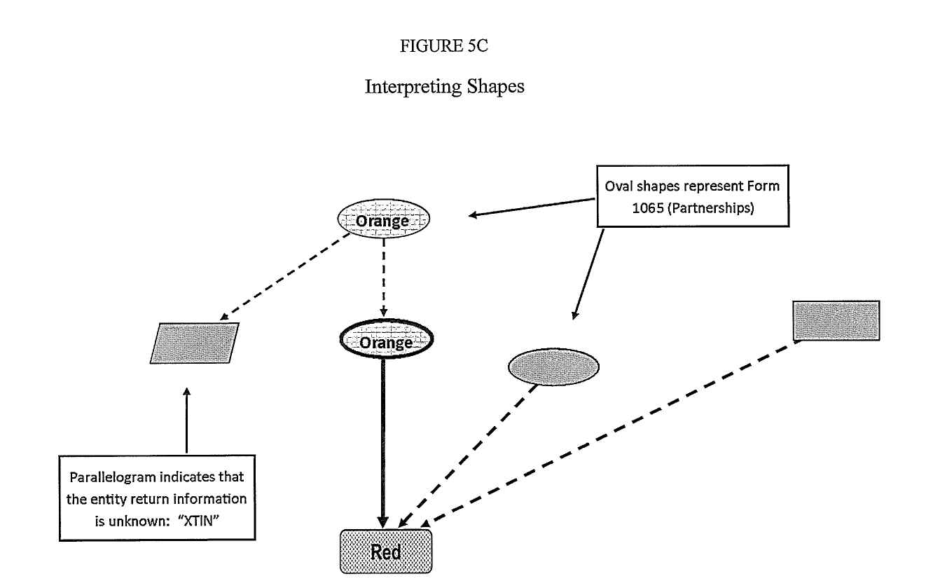

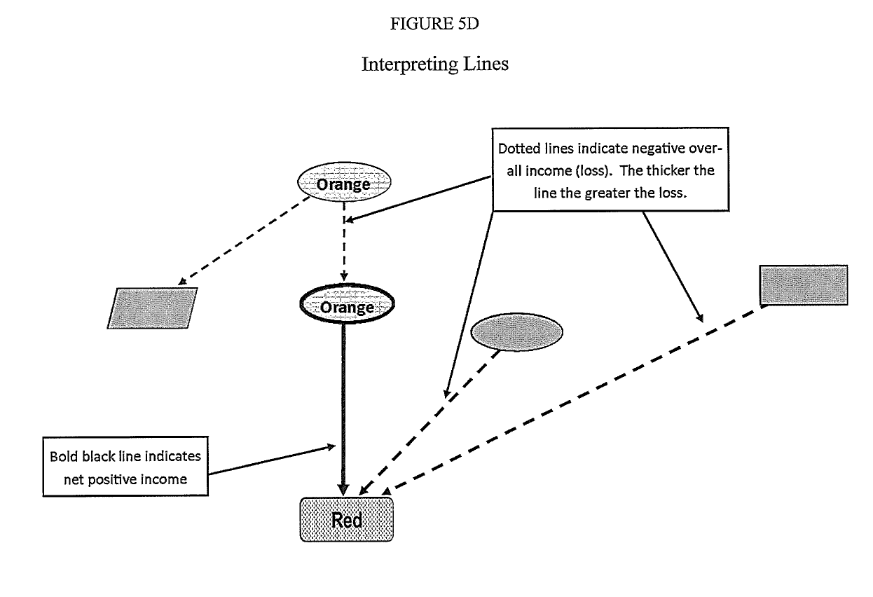

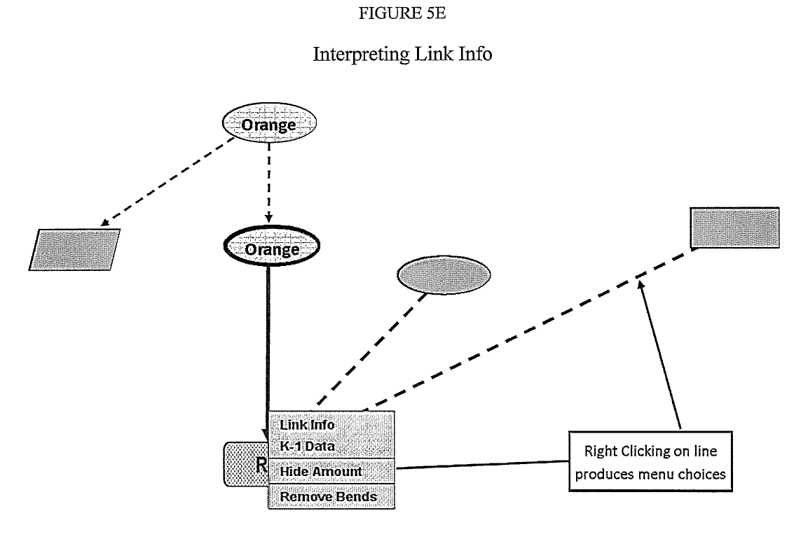

FIGS. 5A through 5E depict visualization of interpreting TINs, colors/patterns, shapes, lines and link information. Each of these characteristics provides information relative to the underlying data existing within the social network. The input TIN entity is identified by bold border. Other linked entities are network related as shown by connecting lines. Color/pattern coding can provide pertinent information relative to asset size, level of income, shelter activity, tax haven or other characteristics. Shapes indicate the type of entity represented and line characteristics can indicate positive/negative numbers or income amount. Graphs can be further interpreted by accessing “drill down” screen menus for additional linked information within the social network such as amounts and payee/payer addresses. FIG. 5A depicts a requested entity by a bold outline, FIG. 5B depicts the graphical output of FIG. 5A and indicates BRTF total assets of >$10,000,000 and a 1040 taxpayer with a TPI of greater than $250K. FIG. 5C denotes partnerships as ovals and the parallelogram as an unknown entity (“XTIN”). Line interpretation is shown in FIG. 5D where dotted lines indicate a negative overall income, where the thicker the line, the greater the loss, and a bold line indicates net positive income. Right clicking on a line produces menu choices, such as K-1 data, hide amounts, and the like, as shown in FIG. 5E. Payer and payee information designated by the link and addresses, income amounts, and the like can also be shown using the right click feature.

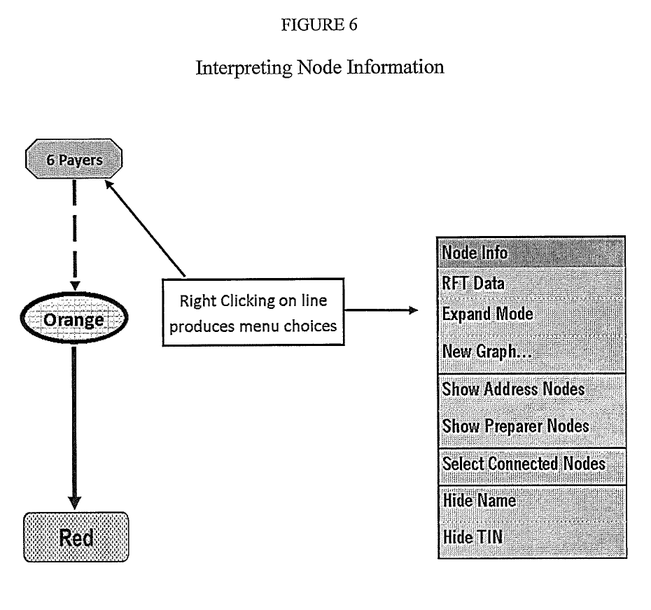

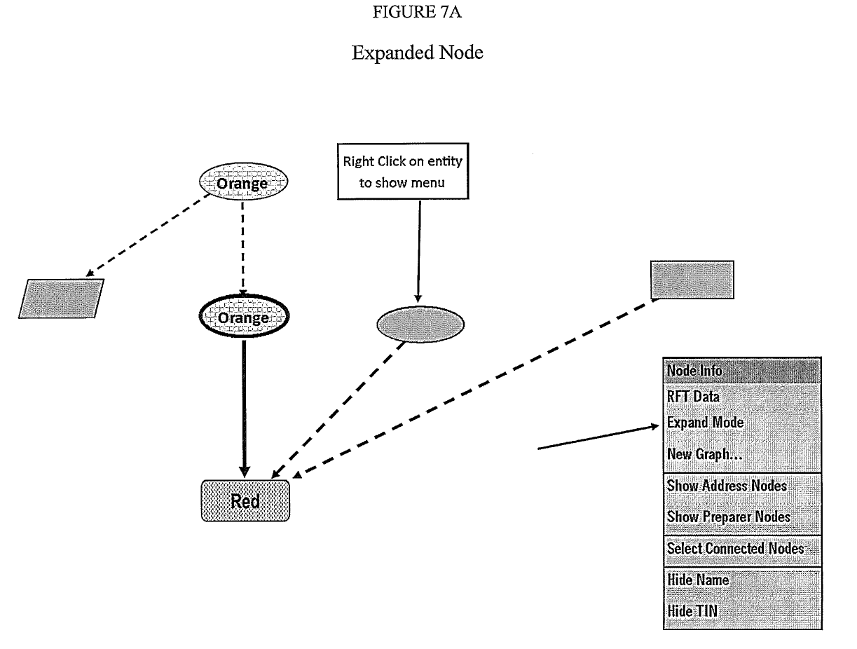

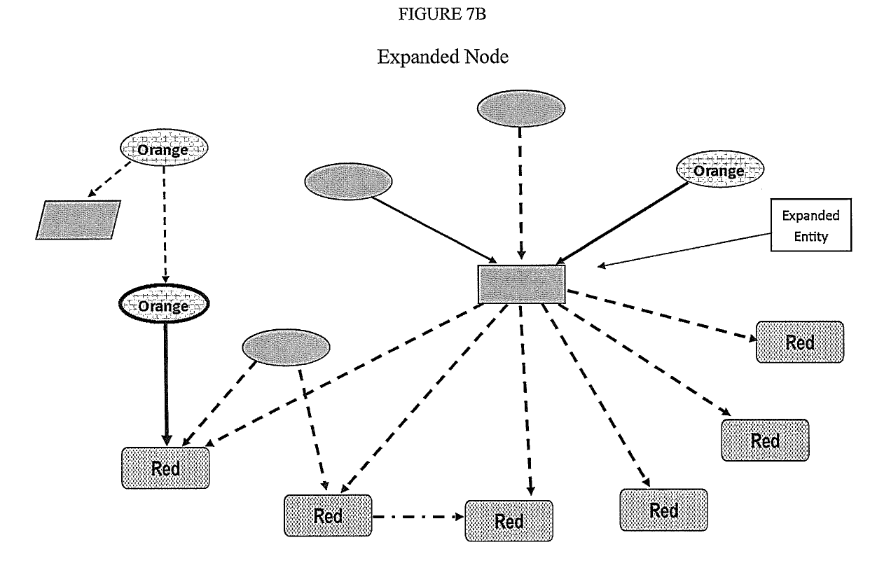

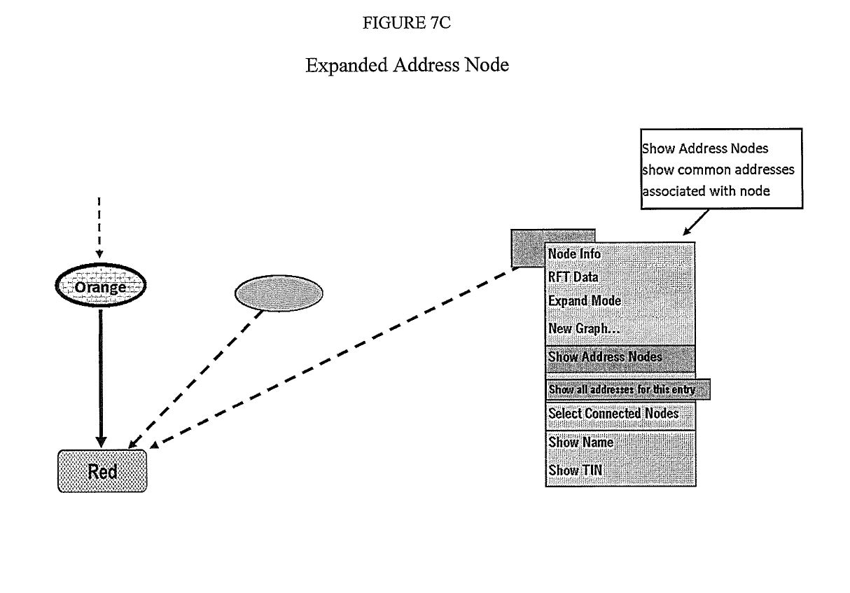

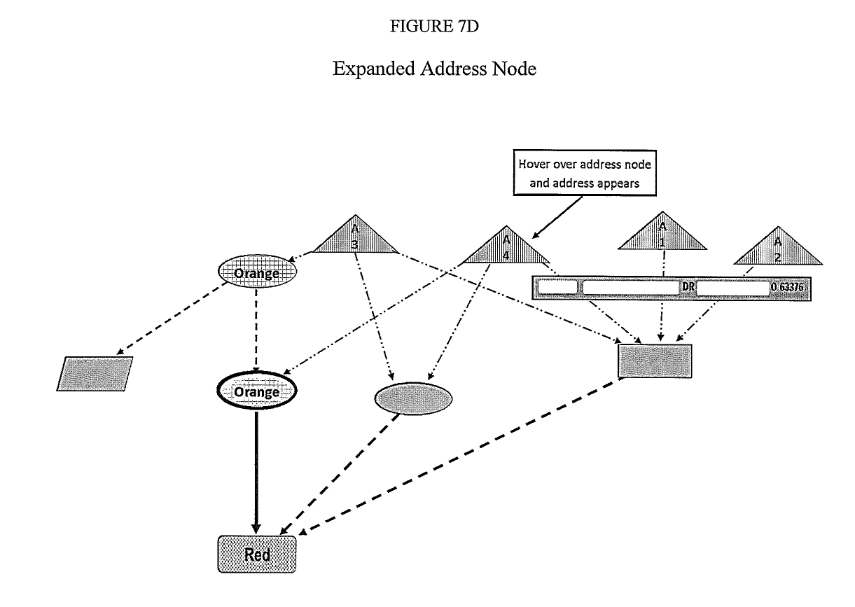

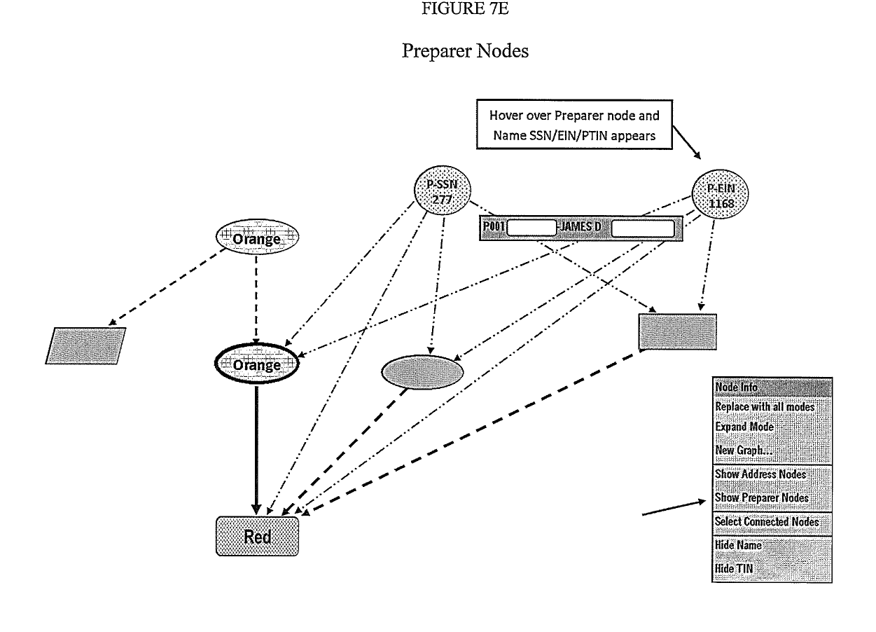

FIG. 6 depicts a visualization of interpreting node information. Right-clicking on a node provides additional information and menu choices for enhancing available data for that node. Additional information can be obtained through the drop-down menu, such as preparer node, address nodes, and the like. Expansion of the nodes can also be chosen by the user as shown in FIGS. 7A through 7E, which provide examples of expanding nodes, for additional information about the entities including common addresses among related entities as well as common preparers. Right clicking on an entity results in the display of a menu as shown in FIG. 7A, where “Expanded Node” can be chosen and displayed as shown in FIG. 7B, or node addresses can be shown as in FIG. 7C.

Hovering over an address node will result in the display of an address as shown in FIG. 7D, whereas hovering over a Preparer Node will result in the display of name, SSN, EIN, PTIN, as shown in FIG. 7E.

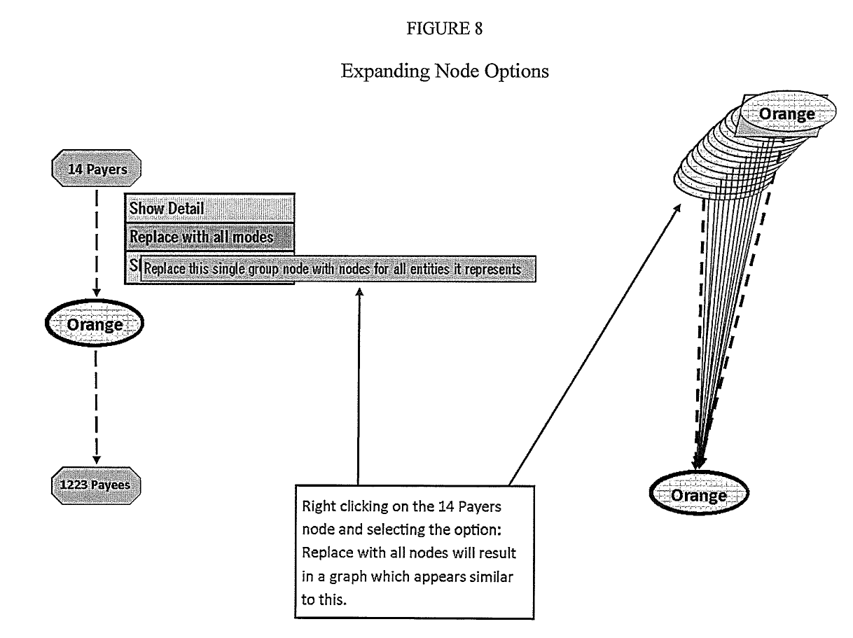

FIG. 8 provides a visualization of options for expanding nodes for additional information. Due to the potential volume of data that could be available in a given situation (i.e.; a partnership receiving 14 K-1s and then issuing 1,223 K-1s to it's partners), PTEV allows for summary node construction when graphing all related entities. In the immediate case, expanding the node with 1,223 payees would not produce a readable graph. In this case a payee table can be presented separately in report form with the ability to pursue payees of interest to the examiner.

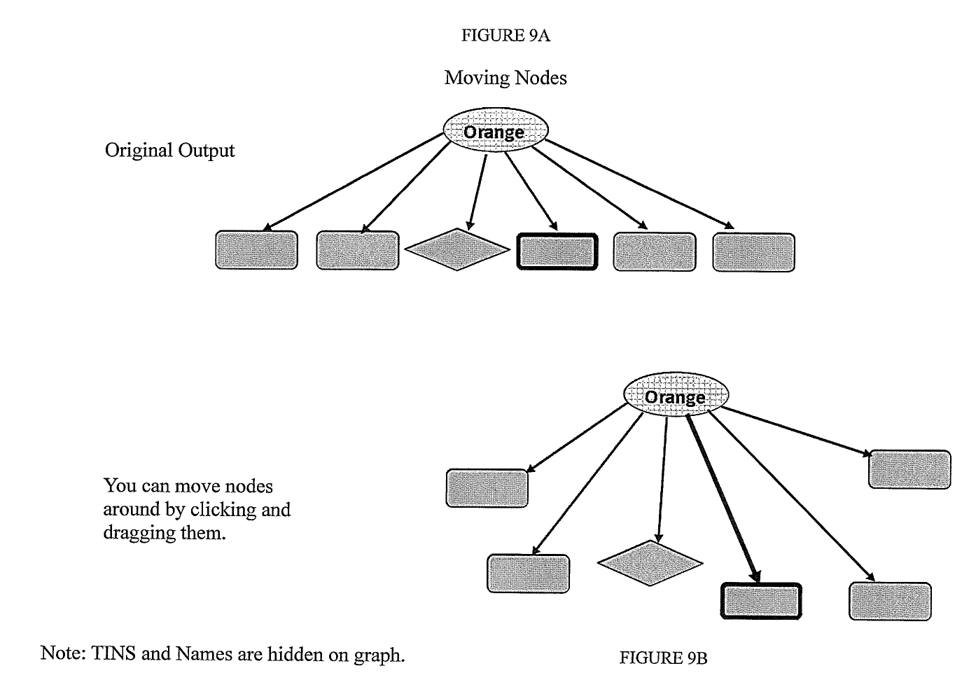

FIG. 9 depicts the visualization of moving nodes using a “click and drag” technique. This function provides the ability to highlight various nodes and provide ease of reading the output. FIG. 9B displays the results of moving the node designations to a user-desired position from the original positions shown in FIG. 9A.

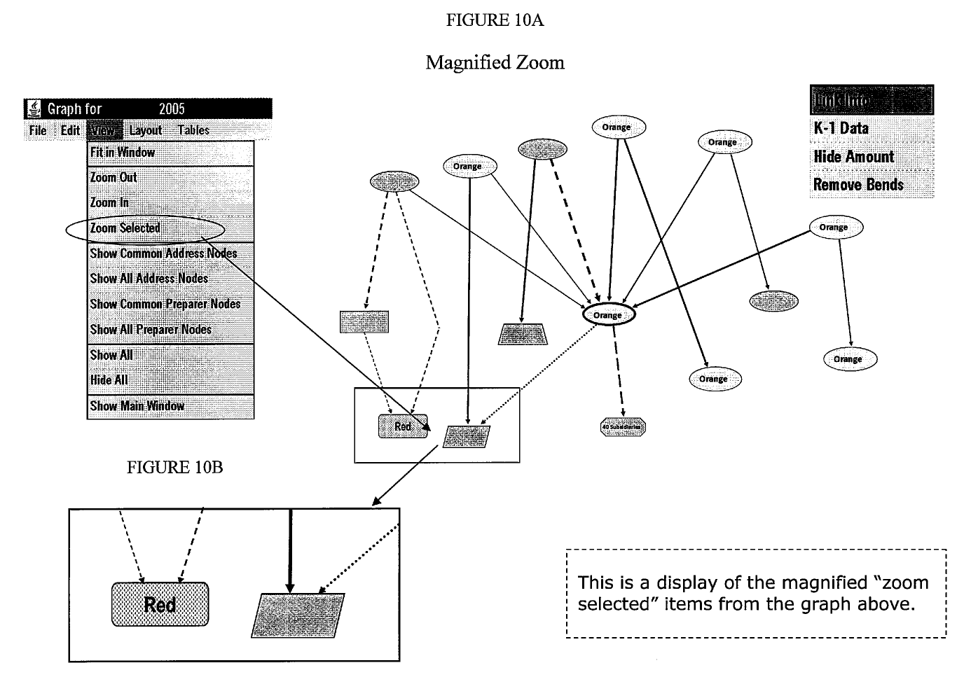

FIG. 10 depicts the visualization of magnified zoom. This allows the ability for the examiner to zoom in on nodes of interest by framing a node or nodes and then selecting the “zoom selected” option from the command box. FIG. 10B depicts a display of the magnified “zoom selected” items from the graph depicted in FIG. 10A.

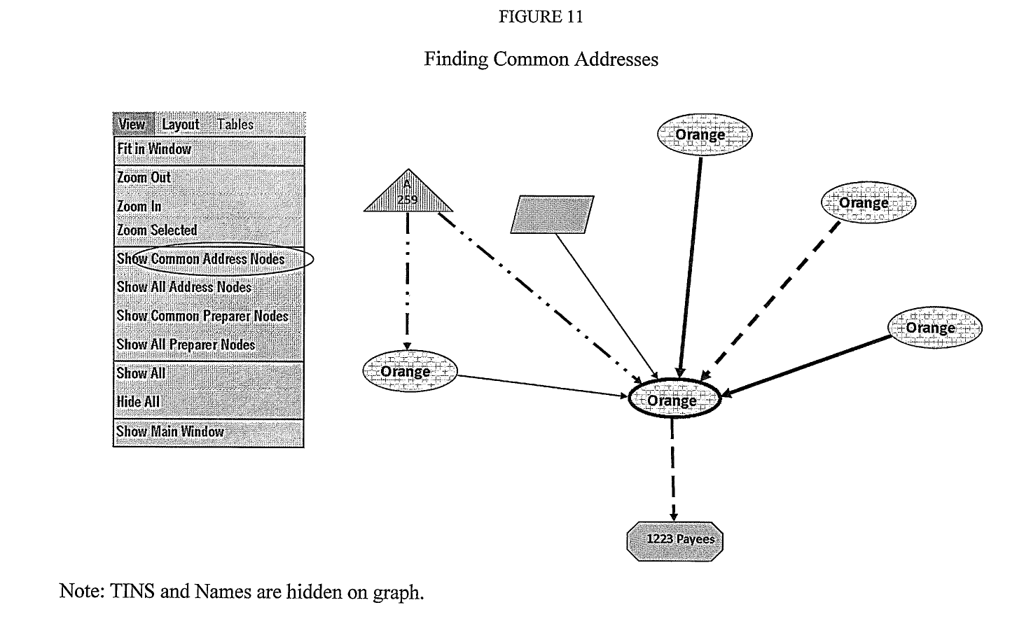

FIG. 11 depicts the visualization of finding common addresses. By invoking the menu and selecting the “Show Common Address Nodes” command, the common addresses are presented in the graph.

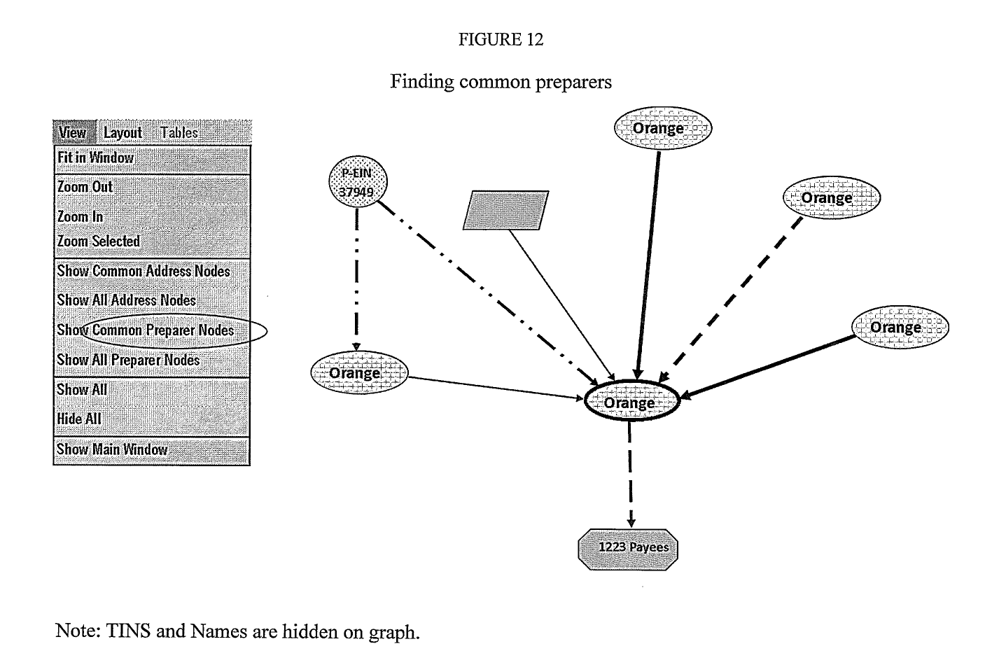

FIG. 12 depicts the visualization of finding common preparers. It operates in much the same way as finding common address nodes.

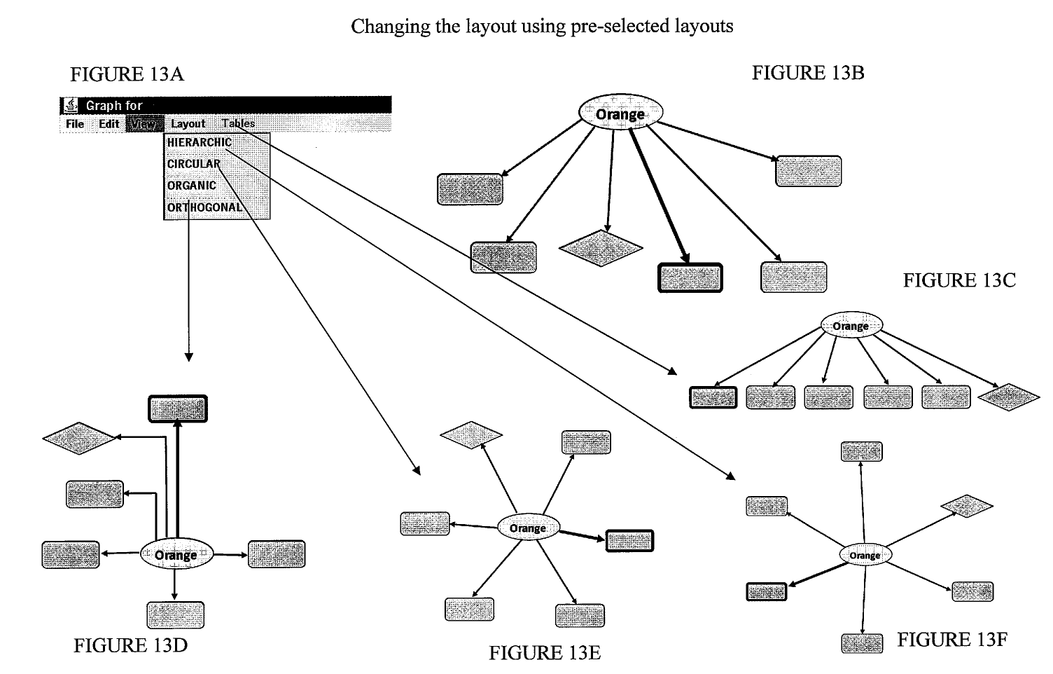

FIGS. 13A-13F depict the visualization of changing layouts using pre-set layout patterns for ease of viewing as shown in the screen menu shown in FIG. 13A. The original graphical organizational representation is shown in FIG. 13B. Options include hierarchic (FIG. 13C), orthogonal (FIG. 13D), organic (FIG. 13E), or circular (FIG. 13F) patterns allowing for the preferred view of the organizational elements.

The present invention includes a taxpayer compliance software program comprising: a computer-implemented software application which accesses taxpayer information from a government agency; and processes the information into a form which can be graphically displayed to the user; and wherein an authorized user accesses data from sources which include, but are not limited to the United States Internal Revenue Service governmental liaison data exchange program extracts; information return master files; individual master files, individual return transaction files; business master files; business return transaction files; modernized electronic files; United States Social Security Administration files; Customs Service International Transportation of Currency of Monetary Instruments reports; state extracts; and state motor vehicle data; and wherein a visual graphic representation of the financial and corporate relationships of a selected entity; and the entity's relationship to other entities is displayed to the use on a computer monitor.

The present invention also includes visualization of the financial and corporate relationships also comprises graphical representation of multiple levels or tiering representing targets of interest and their relationship to the selected entity. Additionally, the invention includes visualization of the financial and corporate relationships which provides information of identities of related entities; identity of high-risk financial patterns; identity of entities presenting tax evasion risks; identity of individual controlling the selected entity; details of each entity interaction; and network analysis of persons, document and economic data. The visualization of the financial and corporate relationships can be visually expanded and/or reorganized as requested by the user. Also, the selected entity is identified by retrieving a personal identifier selected from the group consisting of name, social security number, and taxpayer identification number.

Summary

In summary, the invention includes: a computer software product which identifies abusive tax transactions by pass-through entities, said software product including a computer executable program which performs the steps of: (a) analyzing various IRS, U.S. federal and state tax data, third party data, and international tax data, Internal Revenue Service information return master file data, and tax return information for corporate, S-corp, trust, company and partnership returns; (b) the master file data comprising taxpayer wages, dividends, interest, cash payments, shareholder income, name, identification number and address; (c) generating a node, which allows the display of a graphic representation of a given taxpayer entity and its relationship to other entities; (d) visualization of patterns of taxpayer compliance risk; (e) the visualization including the steps of: (i) identifying related entities, (ii) identifying known high-risk patterns of taxpayer noncompliance and fraud, (iii) identifying related entities presenting compliance risk, (iv) providing detailed information for each node, (v) providing visualizations that can be reorganized to reveal additional compliance risks or clarifications, and (vii) providing a visual diverse network analysis encompassing people, documents, and economic data.

The visualization allows the user to understand who actually controls the enterprise being visualized; the visualization utilizing predetermined shapes as images representing specific entities and establish the relationships between entities with directional arrow lines, and data characteristics represented by shape characteristics, degree of shading, pattern or color as determined by user requirements; incorporating the data that is integrated by information that is capable of linking data together from different databases; providing an output which comprises visualization graphs inclusive of all data that is integrated and which incorporates at least the taxpayer identification number, address, income, deductions, credits, any payments received, and a record of taxes assessed, abated and collected by a government taxing agency; displaying said output on a display screen or tangible output means; and upon selection by a user, exporting the output for documentation and archival uses.

The computer software product also includes the utilization of data sources specific to each customer; utilizes data sources reported by payers on forms selected from the group consisting of: F1096, F1042, F1098, F1099, K-1, F5498, F5500, F8300 and F8362, and all required schedules and attachments; and wherein the data is obtained from the Internal Revenue Service, Department of Labor, Pension Benefit Guaranty Corporation, Social Security Administration, U.S. Customs and Border Protection. The sources of raw data is obtained from: the IRS governmental liaison data exchange program extracts, information return master file, individual master file, individual return transaction files, business master file, business return transaction files, modernized electronic files, state extracts, and state motor vehicle data.

The computer software product also includes a display of multiple levels of tiering representing targets of interest, or data which are desired to bypass; and wherein the output assists a user in the identification of tax haven locations, tax shelter information, total positive income thresholds, and high assets that is capable of being further analyzed by the user.

The invention also includes a method which identifies abusive tax transactions by pass-through entities utilizing a computer executable program which performs the steps of: (a) analyzing various IRS, U.S. federal and state tax data, third party data, and international tax data, Internal Revenue Service information return master file data, and tax return information for corporate, S-corp, trust, company and partnership returns; (b) the master file data comprising taxpayer wages, dividends, interest, cash payments, shareholder income, name, identification number and address; (c) generating a node, which allows the display of a graphic representation of a given taxpayer entity and its relationship to other entities; (d) visualization of patterns of taxpayer compliance risk; (e) the visualization including the steps of: (i) identifying related entities, (ii) identifying known high-risk patterns of taxpayer noncompliance and fraud, (iii) identifying related entities presenting compliance risk, (iv) providing detailed information for each node, (v) providing visualizations that can be reorganized to reveal additional compliance risks or clarifications, and (vii) providing a visual diverse network analysis encompassing people, documents, and economic data.

The visualization allows the user to understand who actually controls the enterprise being visualized; the visualization utilizing predetermined shapes as images representing specific entities and establish the relationships between entities with directional arrow lines, and data characteristics represented by shape characteristics, degree of shading, pattern or color as determined by user requirements; incorporating the data that is integrated by information that is capable of linking data together from different databases; providing an output which comprises visualization graphs inclusive of all data that is integrated and which incorporates at least the taxpayer identification number, address, income, deductions, credits, any payments received, and a record of taxes assessed, abated and collected by a government taxing agency; displaying said output on a display screen or tangible output means; and upon selection by a user, exporting the output for documentation and archival uses.

The method also includes the utilization of data sources specific to each customer;

utilizes data sources reported by payers on forms selected from the group consisting of: F1096, F1042, F1098, F1099, K-1, F5498, F5500, F8300 and F8362, and all required schedules and attachments; and wherein the data is obtained from the Internal Revenue Service, Department of Labor, Pension Benefit Guaranty Corporation, Social Security Administration, U.S. Customs and Border Protection. The sources of raw data is obtained from: the IRS governmental liaison data exchange program extracts, information return master file, individual master file, individual return transaction files, business master file, business return transaction files, modernized electronic files, state extracts, and state motor vehicle data.

The method also produces a display of multiple levels of tiering representing targets of interest, or data which are desired to bypass; and wherein the output assists a user in the identification of tax haven locations, tax shelter information, total positive income thresholds, and high assets that is capable of being further analyzed by the user.

The invention additionally includes a system which identifies abusive tax transactions by pass-through entities which interacts with government tax administration agencies and commercial analytical systems, said system comprising a computer, a display, a secure computer network, workstations, and utilizing a computer executable program which performs the steps of: (a) analyzing various IRS, U.S. federal and state tax data, third party data, and international tax data, Internal Revenue Service information return master file data, and tax return information for corporate, S-corp, trust, company and partnership returns; (b) the master file data comprising taxpayer wages, dividends, interest, cash payments, shareholder income, name, identification number and address; (c) generating a node, which allows the display of a graphic representation of a given taxpayer entity and its relationship to other entities; (d) visualization of patterns of taxpayer compliance risk; (e) the visualization including the steps of: (i) identifying related entities, (ii) identifying known high-risk patterns of taxpayer noncompliance and fraud, (iii) identifying related entities presenting compliance risk, (iv) providing detailed information for each node, (v) providing visualizations that can be reorganized to reveal additional compliance risks or clarifications, and (vii) providing a visual diverse network analysis encompassing people, documents, and economic data.

The visualization allows the user to understand who actually controls the enterprise being visualized; the visualization utilizing predetermined shapes as images representing specific entities and establish the relationships between entities with directional arrow lines, and data characteristics represented by shape characteristics, degree of shading, pattern or color as determined by user requirements; incorporating the data that is integrated by information that is capable of linking data together from different databases; providing an output which comprises visualization graphs inclusive of all data that is integrated and which incorporates at least the taxpayer identification number, address, income, deductions, credits, any payments received, and a record of taxes assessed, abated and collected by a government taxing agency; displaying said output on a display screen or tangible output means; and upon selection by a user, exporting the output for documentation and archival uses.

The system also includes the computer software product which utilizes data sources specific to each customer; utilizes data sources reported by payers on forms selected from the group consisting of: F1096, F1042, F1098, F1099, K-1, F5498, F5500, F8300 and F8362, and all required schedules and attachments; and wherein the data is obtained from the Internal Revenue Service, Department of Labor, Pension Benefit Guaranty Corporation, Social Security Administration, U.S. Customs and Border Protection. The sources of raw data is obtained from: the IRS governmental liaison data exchange program extracts, information return master file, individual master file, individual return transaction files, business master file, business return transaction files, modernized electronic files, state extracts, and state motor vehicle data.

The system also includes the computer software product which produces a display of multiple levels of tiering representing targets of interest, or data which are desired to bypass; and wherein the output assists a user in the identification of tax haven locations, tax shelter information, total positive income thresholds, and high assets that is capable of being further analyzed by the user.

Having now fully described this invention, it will be understood to those of ordinary skill in the art that the same can be performed within a wide and equivalent range of conditions, formulations, and other parameters without affecting the scope of the invention or any embodiment thereof. All patents and publications cited herein are incorporated by reference in their entirety.

I claim:

1. A computer software product which identifies abusive tax transactions by pass-through entities, said software product comprising a computer executable program which performs the steps of:
a. analyzing U.S. federal and state tax data, third party data, and international tax data, Internal Revenue Service information return master file data, and tax return information for corporate, S-corp, trust, company and partnership returns;
b. said master file data comprising taxpayer wages, dividends, interest, cash payments, shareholder income, name, identification number and address;
c. generating a node, which comprises a graphic representation of a given taxpayer entity and its relationship to other entities;
d. visualization of patterns of taxpayer compliance risk;
e. said visualization comprising the steps of:
i. identifying related entities,
ii. identifying known high-risk patterns of taxpayer noncompliance and fraud,
iii. identifying related entities presenting compliance risk,
iv. providing detailed information for each node,
v. providing visualizations that can be reorganized to reveal additional compliance risks or clarifications, and
vi. providing a visual diverse network analysis encompassing people, documents, and economic data; and
f. wherein said visualization allowing the user to understand who actually controls the enterprise being visualized;
g. said visualization utilizing predetermined shapes as images representing specific entities and establish the relationships between entities with directional arrow lines, and data characteristics represented by shape characteristics, degree of shading, pattern or color as determined by user requirements;
h. said visualization incorporating the data that is integrated by information that is capable of linking data together from different databases;
i. providing an output which comprises visualization graphs inclusive of all data that is integrated and which incorporates at least the taxpayer identification number, address, income, deductions, credits, any payments received, and a record of taxes assessed, abated and collected by a government taxing agency;
j. displaying said output on a display screen or tangible output means; and
k. upon selection by a user, exporting the output for documentation and archival uses.

2. The computer software product of claim 1, wherein the software product utilizes data sources specific to each customer.

3. The computer software product of claim 1, wherein the software product utilizes data sources reported by payers on forms selected from the group consisting of:
F1096, F1042, F1098, F1099, K-1, F5498, F5500, F8300 and F8362, and all required schedules and attachments.

4. The computer software product of claim 1, wherein data is obtained from the Internal Revenue Service, Department of Labor, Pension Benefit Guaranty Corporation, Social Security Administration, U.S. Customs and Border Protection.

5. The computer software product of claim 1, wherein sources of raw data is obtained from the group selected from: the IRS governmental liaison data exchange program extracts, information return master file, individual master file, individual return transaction files, business master file, business return transaction files, modernized electronic files, state extracts, and state motor vehicle data.

6. The computer software product of claim 1, wherein a display of multiple levels of tiering representing targets of interest, or data which are desired to bypass.

7. The computer software product of claim 1, wherein the output assists a user in the identification of tax haven locations, tax shelter information, total positive income thresholds, and high assets that is capable of being further analyzed by the user.

8. A method which identifies abusive tax transactions by pass-through entities utilizing a computer executable program which performs the steps of:
a. analyzing U.S. federal and state tax data, third party data, and international tax data, Internal Revenue Service information return master file data, and tax return information for corporate, S-corp, trust, company and partnership returns;
b. said master file data comprising taxpayer wages, dividends, interest, cash payments, shareholder income, name, identification number and address;
c. generating a node, which comprises a graphic representation of a given taxpayer entity and its relationship to other entities;
d. visualization of patterns of taxpayer compliance risk;
e. said visualization comprising the steps of:
i. identifying related entities,
ii. identifying known high-risk patterns of taxpayer noncompliance and fraud,
iii. identifying related entities presenting compliance risk,
iv. providing detailed information for each node,
v. providing visualizations that can be reorganized to reveal additional compliance risks or clarifications, and
vi. providing a visual diverse network analysis encompassing people, documents, and economic data; and
f. wherein said visualization allowing the user to understand who actually controls the enterprise being visualized;
g. said visualization utilizing predetermined shapes as images representing specific entities and establish the relationships between entities with directional arrow lines, and data characteristics represented by shape characteristics, degree of shading, pattern or color as determined by user requirements;
h. said visualization incorporating the data that is integrated by information that is capable of linking data together from different databases;
i. providing an output which comprises visualization graphs inclusive of all data that is integrated and which incorporates at least the taxpayer identification number, address, income, deductions, credits, any payments received, and a record of taxes assessed, abated and collected by a government taxing agency;
j. displaying said output on a display screen or tangible output means; and
k. upon selection by a user, exporting the output for documentation and archival uses.

9. The method of claim 8, wherein the software product utilizes data sources specific to each customer.

10. The method of claim 8, wherein the software product utilizes data sources reported by payers on forms selected from the group consisting of: F1096, F1042, F1098, F1099, K-1, F5498, F5500, F8300 and F8362, and all required schedules and attachments.

11. The computer software product of claim 8, wherein data is obtained from the Internal Revenue Service, Department of Labor, Pension Benefit Guaranty Corporation, Social Security Administration, U.S. Customs and Border Protection.

12. The method of claim 8, wherein sources of raw data is obtained from the group selected from: the IRS governmental liaison data exchange program extracts, information return master file, individual master file, individual return transaction files, business master file, business return transaction files, modernized electronic files, state extracts, and state motor vehicle data.

13. The method of claim 8, wherein a display of multiple levels of tiering representing targets of interest, or data which are desired to bypass.

14. The method of claim 8, wherein the output assists a user in the identification of tax haven locations, tax shelter information, total positive income thresholds, and high assets that is capable of being further analyzed by the user.

15. A system which identifies abusive tax transactions by pass-through entities which interacts with government tax administration agencies and commercial analytical systems, said system comprising a computer, a display, a secure computer network, workstations, and utilizing a computer executable program which performs the steps of:
a. analyzing U.S. federal and state tax data, third party data, and international tax data, Internal Revenue Service information return master file data, and tax return information for corporate, S-corp, trust, company and partnership returns;
b. said master file data comprising taxpayer wages, dividends, interest, cash payments, shareholder income, name, identification number and address;
c. generating a node, which comprises a graphic representation of a given taxpayer entity and its relationship to other entities;
d. visualization of patterns of taxpayer compliance risk;
e. said visualization comprising the steps of:
i. identifying related entities,
ii. identifying known high-risk patterns of taxpayer noncompliance and fraud,
iii. identifying related entities presenting compliance risk,
iv. providing detailed information for each node,
v. providing visualizations that can be reorganized to reveal additional compliance risks or clarifications, and
vi. providing a visual diverse network analysis encompassing people, documents, and economic data; and
f. wherein said visualization allowing the user to understand who actually controls the enterprise being visualized;
g. said visualization utilizing predetermined shapes as images representing specific entities and establish the relationships between entities with directional arrow lines, and data characteristics represented by shape characteristics, degree of shading, pattern or color as determined by user requirements;
h. said visualization incorporating the data that is integrated by information that is capable of linking data together from different databases;
i. providing an output which comprises visualization graphs inclusive of all data that is integrated and which incorporates at least the taxpayer identification number, address, income, deductions, credits, any payments received, and a record of taxes assessed, abated and collected by a government taxing agency;
j. displaying said output on a display screen or tangible output means; and
k. upon selection by a user, exporting the output for documentation and archival uses.

16. The system of claim 15, wherein the software product utilizes data sources specific to each customer.

17. The system of claim 15, wherein the software product utilizes data sources reported by payers on forms selected from the group consisting of: F1096, F1042, F1098, F1099, K-1, F5498, F5500, F8300 and F8362, and all required schedules and attachments.

18. The computer software product of claim 15, wherein data is obtained from the Internal Revenue Service, Department of Labor, Pension Benefit Guaranty Corporation, Social Security Administration, U.S. Customs and Border Protection.

19. The system of claim 15, wherein sources of raw data is obtained from the group selected from: the IRS governmental liaison data exchange program extracts, information return master file, individual master file, individual return transaction files, business master file, business return transaction files, modernized electronic files, state extracts, and state motor vehicle data.

20. The system of claim 15, wherein a display of multiple levels of tiering representing targets of interest, or data which are desired to bypass.

21. The system of claim 15, wherein the output assists a user in the identification of tax haven locations, tax shelter information, total positive income thresholds, and high assets that is capable of being further analyzed by the user.
